(19) United States
(12) Patent Application Publication
(10) Pub. No.: US 2024/0193632 A1
(43) Pub. Date: Jun. 13, 2024

(54) INFORMATION PROCESSING DEVICE AND METHOD

(71) Applicant: Toshiba Tec Kabushiki Kaisha, Tokyo (JP)

(72) Inventor: Yusuke MINOURA, Sunto Shizuoka (JP)

(21) Appl. No.: 18/471,252

(22) Filed: Sep. 20, 2023

(30) Foreign Application Priority Data
Dec. 7, 2022 (JP) 2022-195589

(51) Int. Cl. G06Q 30/0207; G06Q 50/12

(52) U.S. Cl. CPC G06Q 30/0207; G06Q 50/12

(57) ABSTRACT

An information processing device for store management includes a storage unit and a control unit. The control unit calculates congestion values for a store based on the number of occupied seats and the total number of seats in the store, identifies whether the store is in an off-peak state based on a congestion value, and acquire information indicating whether an item ordered by a customer has already been provided to the customer. The control unit determines based on the acquired provision information whether all ordered items for a table have been provided. When the store is in the off-peak state, the control unit causes a coupon to be transmitted to the table for which all ordered items have already been provided to the customers. The coupon grants a privilege associated with the placing of an additional order for an item during the present store visit.

### CROSS-REFERENCE TO RELATED APPLICATION

This application is based upon and claims the benefit of priority from Japanese Patent Application No. 2022-195589, filed Dec. 7, 2022, the entire contents of which are incorporated herein by reference.

### FIELD

Embodiments described herein relate generally to an information processing device and a method.

### BACKGROUND

In the related art, a system for increasing sales has been introduced at stores, restaurants or the like. With such a system customers can be attracted by transmitting privilege (benefit) information, such as coupons or promotional offers, to a user terminal located nearby the store/restaurant location. Such privilege information may be set according to the availability of items (stock) and/or the current business situation of the store or restaurant.

In the system of the related art, when the store is in an off-peak state in which a commodity can be provided to a customer immediately without waiting, the privilege information can be transmitted to the user terminal (s) located near the store. The system of the related art attracts customers by prompting a user outside the store to visit the store when the store is in the off-peak state.

However, the timing at which a restaurant is in the off-peak state and the timing at which the people outside the restaurant are ready to eat and drink are not well linked and may even be inversely related in normal circumstances. Therefore, the system of the related art does not necessarily have significant customer attracting effect, and there is room for improvement for increasing sales of a store or a restaurant.

### BRIEF DESCRIPTION OF THE DRAWINGS

FIG. 1 is a diagram schematically showing a store system according to an embodiment.

FIG. 2 is a block diagram of a server device.

FIG. 3 is a diagram showing a data configuration of a commodity master stored in a storage unit.

FIG. 4 is a diagram showing a data configuration of a congestion degree determination table.

FIG. 5 is a diagram showing a data configuration of a waiting customer management table.

FIG. 6 is a diagram showing a data configuration of a seat management table.

FIG. 7 is a diagram showing a data configuration of a coupon setting table.

FIG. 8 is a diagram showing a data configuration of an order information management table.

FIG. 9 is a diagram showing a data configuration of a prohibition information setting table.

FIG. 10 is a diagram showing a data configuration of a checkout management table.

FIG. 11 is a block diagram of a control unit.

FIG. 12 is a sequence chart showing a flow of operations in a store system.

FIG. 13 is a flowchart of a coupon dispensing process.

FIG. 14 is a flowchart of a checkout process.

### DETAILED DESCRIPTION

In general, according to one embodiment, an improved information processing device and a method that can increase sales for a store by prompting a customer already in the store to place an additional order when the store is in an off-peak state are provided.

According to one embodiment, an information processing device for store management includes a storage unit and a control unit. The control unit is configured to calculate a congestion value for a store based on a number of presently occupied seats and a total number of seats in the store, identify whether the store is in an off-peak state when a congestion value is equal to or less than a first set value, acquire item provision information indicating whether an item ordered by a customer in the store has been provided to the customer, determine, based on the acquired provision information, whether all ordered items of customers at a table have been provided to the customers, and, when the store is in the off-peak state, transmit a first coupon to the table for which all ordered items for the customers at the table have been provided to the customers. The first coupon granting a privilege associated with a placing of an additional order for an item during the same store visit or the like.

Hereinafter, an information processing device and a program according to certain example embodiments will be described with reference to the drawings. The present disclosure is not limited to these specific examples. For example, in an embodiment, an information terminal on a seat in a store is provided as an order terminal, but the present disclosure is not limited thereto. In other examples, the order terminal may be a customer terminal owned by a customer, such as a smartphone or a tablet terminal in which an order application program (“ordering app”) is installed.

In an embodiment, a server device outputs a privilege notification to the order terminal, but the present disclosure is not limited thereto. For example, the server device may output the privilege notification to a display device separately provided in the store from the order terminal. In this case, it may be desirable that the display device displays the content of the privilege notification along with customer identification information (such as a table number) for identifying the customer to be granted the privilege. That is, a method for notifying the customer of the privilege information is not limited to the method using the order terminal provided on the seat.

Further, in an embodiment, a coupon that grants a privilege to the customer is used as an example of the privilege notification. The coupon may be used under a condition that the customer first declares an intention to use the coupon. In other words, the customer applies for or requests to use of the coupon at the store, but the present disclosure is not limited thereto. The privilege notification may simply be a notification indicating the content of the privilege and use need not be contingent on first applying or requesting to use associated privilege/benefit. The customer thus does not need to input information indicating that the coupon is to be used, and the privilege may be automatically granted to the customer when the customer makes a payment.

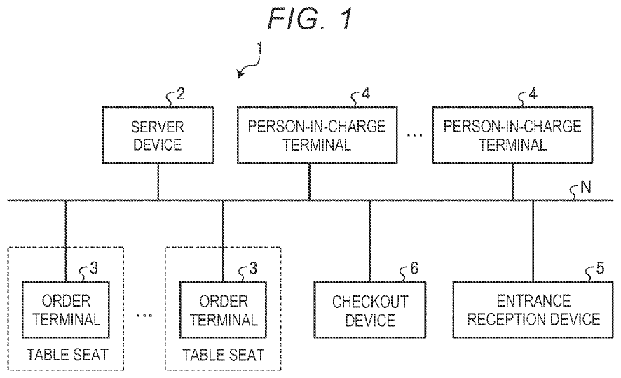

FIG. 1 is a diagram showing an outline of a store system 1 including a server device 2 as an example of an information processing device. A store system 1 according to the present embodiment is applied to, for example, a restaurant including a plurality of table seats (tables).

The store system 1 includes a server device 2, order terminals 3 provided at respective table seats, person-in-charge terminals 4 each of which is to be carried by an employee of the store, an entrance reception device 5, and a checkout device 6. The server device 2, the order terminals 3, the person-in-charge terminals 4, the entrance reception device 5, and the checkout device 6 are communicably connected to one another via a network N such as a wireless local area network (LAN). The number of each device included in the store system 1 is not limited to the depicted example.

The server device 2 manages various types of information about a store. For example, the server device 2 manages order information, checkout information, congestion information, and the like based on information received from the order terminals 3, the person-in-charge terminals 4, the entrance reception device 5, and the checkout device 6. Further, the server device 2 manages a commodity master storing commodity information about commodities sold by the store. When there is a change in a menu of the store, the server device 2 appropriately updates the commodity master and transmits the updated commodity master to the order terminals 3 or the person-in-charge terminals 4. The server device 2 may comprises a plurality of computers. In other words, functions of the server device 2 may be distributed among the plurality of computers. In addition, the functions of the server device 2 may be implemented by cloud computing or the like.

When the store is in an off-peak state with few customers in the store, the server device 2 notifies a customer (or table) for whom all ordered commodities have already been provided of a certain type of privilege information. In the present embodiment, the server device 2 notifies the customer of the privilege information by transmitting a first coupon to the order terminal 3 provided at the table of the corresponding customer (s). The first coupon transmitted by the server device 2 is, for example, a discount coupon for the ordering of another commodity during the present store visit. Accordingly, the store can entice an additional order from a customer already in the store during the off-peak state rather than attempt to bring in additional customers to the store during the off-peak state.

In addition, when the store is in a congested state where there are many customers presently in the store, the server device 2 notifies a customer (or table) for whom all ordered commodities have already been provided of a certain other type of privilege information. When the store is in the congested state, the server device 2 notifies the customer of privilege information by transmitting a second coupon to the order terminal 3 provided at the table of the corresponding customer (s). The second coupon transmitted by the server device 2 is, for example, a discount coupon to be applied under a condition that the customer leaves the store within 15 minutes. For example, the second coupon may be applicable only on a subsequent store visit rather than for the placing of an additional order or the like during the current visit. Accordingly, the store can promote increased customer (table) turnover rate due to customers leaving the store faster when the store is in the congested state to obtain the benefit of the second coupon.

The first coupon that is transmitted when the store is in the off-peak state is an example of a first privilege notification output by the server device 2. The second coupon that is transmitted when the store is in the congested (busy) state is an example of a second privilege notification output by the server device 2.

The server device 2 prohibits the transmission of the second coupon after receiving prohibition information. The prohibition information can be freely set by the store. For example, the store can set, as the prohibition information, order information indicating a commodity such as bottomless drinks and multi-course dishes for which the store typically allows the customer to stay for only a predetermined period of time. The store can prevent the customer who orders such a commodity from feeling uncomfortable due to the transmission of the second coupon which might prompt the customer to leave the store early.

The store can set a table number received from the person-in-charge terminal 4 as the prohibition information. The table number is an example of customer identification information by which a particular customer can be identified. The store can prohibit the transmission of the second coupon to any customer according to a decision of a store manager or table server. The store can prohibit the transmission of the second coupon to a customer who might be considered, by the person in charge, to be made uncomfortable by receiving the second coupon.

Similarly, when it is considered by the store not to be convenient, the transmission of the first coupon may be prohibited as necessary. The prohibition information for prohibiting or limiting the transmission of the first coupon can be freely set by the store.

An order terminal 3 can be provided on each table seat in the store. The order terminal 3 includes a monitor that displays various types of information. The monitor displays a menu of items (commodities) sold by the store, a commodity order input screen, a coupon received from the server device 2, a coupon usage request input screen for declaring use of the coupon, and the like. The order terminal 3 transmits information input on the various input screens to the server device 2.

The person-in-charge terminal 4 is an information device that may be referred to as a handy terminal or a handheld terminal device. The person-in-charge terminal 4 is carried by an employee (hereinafter also referred to as a “person in charge”) who responds to a customer on the floor on which the table seats are disposed. The person-in-charge terminal 4 transmits various types of information to the server device 2. For example, the person-in-charge terminal 4 transmits order information indicating an order of a commodity that is input by the person in charge. When an order is orally received from the customer, the person in charge inputs the order information to the person-in-charge terminal 4.

For example, the person-in-charge terminal 4 transmits guidance information input by the person in charge to the server device 2. The guidance information is information indicating that the customer has been guided to a table seat and includes a table number of the table seat. The person-in-charge terminal 4 transmits the prohibition information input by the person in charge to the server device 2. The prohibition information is information indicating that there is a customer to whom the person in charge does not want to transmit a second coupon, and includes the table number of the table seat at which the customer is seated.

The entrance reception device 5 is provided, for example, near an entrance of the store. The entrance reception device 5 may be operated by a customer who visits the store or the person in charge. The number of customers who desire to enter the store is input to the entrance reception device 5. The entrance reception device 5 dispenses an entrance waiting number in association with the input number of customers. The entrance reception device 5 transmits the entrance waiting information in which the dispensed entrance waiting number is associated with the number of customers to the server device 2.

The checkout device 6 is, for example, a self-checkout device with which a customer performs payment of a fee by himself or herself. The checkout device 6 transmits an input checkout code to the server device 2 and receives payment information corresponding to the checkout code from the server device 2. The payment information is information necessary for the customer to perform payment (transaction settlement) and includes commodity information (commodity name, price, quantity, and the like) of purchased items, an amount of payment (total amount due for purchased items/commodities), and the like.

The checkout device 6 reads the checkout code with, for example, a scanner provided in the checkout device 6 itself. The checkout device 6 reads the checkout code printed on a checkout slip received by the customer from the person in charge. When the customer terminal is the order terminal, the checkout device 6 reads the checkout code displayed on the customer terminal. The checkout code may be manually input to the checkout device 6. The checkout device 6 may be a checkout device operated by the employee such as the person in charge.

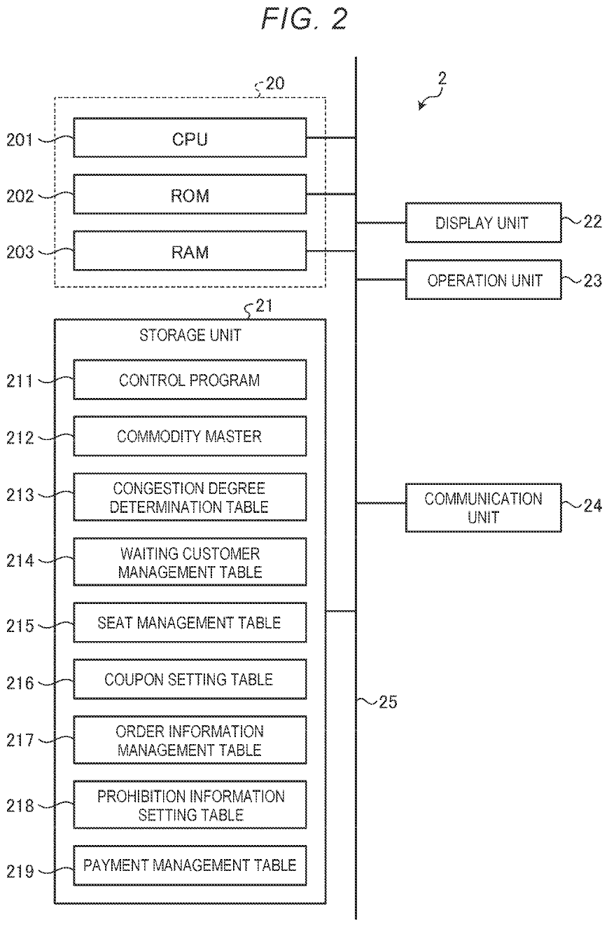

Next, the server device 2 will be described. FIG. 2 is a block diagram showing a hardware configuration of the server device 2. The server device 2 includes a control unit 20, a storage unit 21, a display unit 22, an operation unit 23, and a communication unit 24. The control unit 20, the storage unit 21, the display unit 22, the operation unit 23, and the communication unit 24 are connected to one another via a bus 25 or the like.

The control unit 20 includes a central processing unit (CPU) 201, a read only memory (ROM) 202, and a random access memory (RAM) 203. The CPU 201, the ROM 202, and the RAM 203 are connected to one another via the bus 25.

The CPU 201 controls an overall operation of the server device 2. The ROM 202 stores various programs such as a program used for driving the CPU 201 and various types of data. The RAM 203 is used as a work area of the CPU 201, and loads the various programs and various types of data stored in the ROM 202 and the storage unit 21. The control unit 20 executes various types of control processes of the server device 2 by the CPU 201 operating according to control programs stored in the ROM 202 and the storage unit 21 and loaded in the RAM 203.

The storage unit 21 is implemented as a storage medium such as a hard disk drive (HDD) or a flash memory, and maintains a storage content even when a power supply is cut off. The storage unit 21 stores a control program 211, a commodity master 212, a congestion degree determination table 213, a waiting customer management table 214, a seat management table 215, a coupon setting table 216, order an information management table 217, a prohibition information setting table 218, and a checkout management table 219.

The control program 211 is a program for implementing a function of transmitting and receiving various types of information to and from the order terminals 3, the person-in-charge terminals 4, the entrance reception device 5, and the checkout device 6, a function of calculating a congestion degree, a function of transmitting a coupon according to the calculated congestion degree and provision information f an ordered commodity to a customer, and the like.

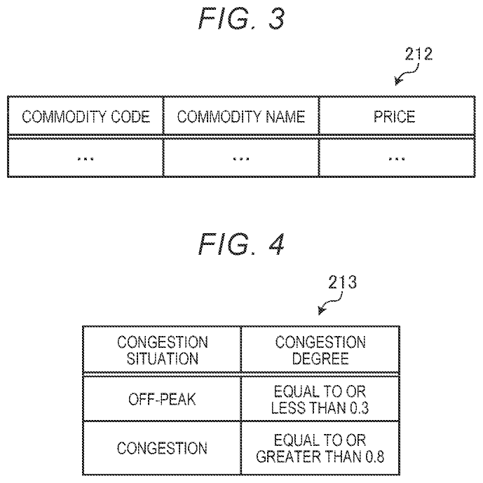

The commodity master 212 is a master file for managing commodity information about the commodities sold in the store. The commodity master 212 can be said to be a file for managing a menu of commodities provided to the customer by the store. FIG. 3 is a diagram showing a data configuration of the commodity master 212. The commodity master 212 stores a commodity name and a price in association with a commodity code.

The commodity code is information for identifying a commodity and is an example of commodity identification information. The commodity name is information indicating a name of a commodity. The price is information indicating a price of a commodity. The commodity master 212 may store other commodity information such as a commodity image.

The congestion degree determination table 213 is a data table for determining whether a congestion situation in the store is the off-peak state or the congested state. The congestion degree determination table 213 can be updated by the store as appropriate. FIG. 4 is a diagram showing a data configuration of the congestion degree determination table 213. The congestion degree determination table 213 stores the congestion situation and the congestion degree in association with each other.

The congestion situation is information indicating a congestion situation at the store (how busy or full is the store) and is information that indicates an off-peak state or congested (busy/full) state. The congestion degree is information indicating the congestion degree as calculated by a set calculation method. In the present embodiment, the congestion situation is determined to be the off-peak state when the congestion degree is equal to or less than 0.3 and is determined to be the congested state when the congestion degree is equal to or greater than 0.8. When the congestion degree is greater than 0.3 but less than 0.8, the congestion situation is determined to be a normal state. A numerical value (threshold) of the congestion degree can be freely set by the store.

Here, an example of a method for calculating the congestion degree will be described. In the present embodiment, the congestion degree is calculated as follows:

Congestion Degree=(Number of Table Seats in Use+Number of Table Seats to be Used By Customers Waiting for Entering Store)/Total Number of Table Seats in Store

The number of table seats in use is the number of table seats being used by customers. The number of table seats to be used by customers waiting for entering the store is the number of table seats estimated to be used when the customers presently waiting to enter the store enter the store. For example, when there are five groups of customers waiting for entering the store and the customers in each group are within the number of persons who can sit at one table seat, the number of the table seats to be used by customers waiting for entering the store is five. When one of the five groups of customers waiting has the number of persons who need to use two table seats, and customers of each of other groups are within the number of persons who can sit at one table seat, the number of table seats to be used by customers waiting for entering the store is six. The total number of table seats in store is the number of table seats available in the store (maximum capacity). The number of table seats in use, the number of table seats to be used by customers waiting for entering the store, the number of table seats in store, and the information for calculating these numbers which are necessary for calculating the congestion degree are examples of the congestion information.

For example, when the number of table seats in the store is 10, the number of table seats in use is 2, and the number of table seats to be used by customers waiting for entering the store is 0, the congestion degree is 0.2. Accordingly, the congestion situation is determined as “off-peak”. If the number of table seats in the store is 10, the number of table seats in use is 8, and the number of table seats to be used by customers waiting for entering the store is 5 (with 2 table seats being cleaned up), the congestion degree is 1.3. Accordingly, the congestion situation is determined as “congested”. The method for calculating the congestion degree can be appropriately set according to preferences and circumstances of each store such as the arrangement of the table seats and counter seats.

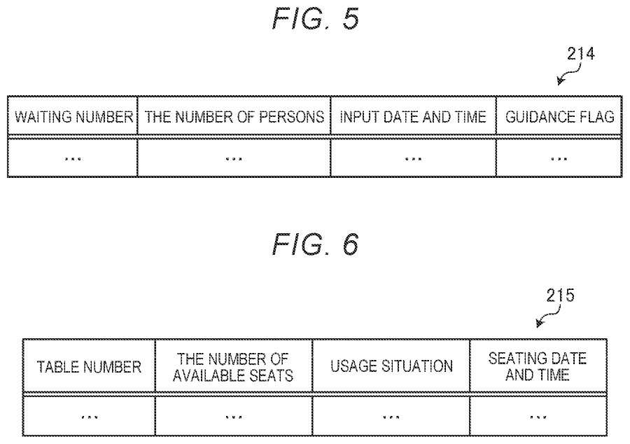

The waiting customer management table 214 is a data table for managing a situation of customers waiting for entering the store. The waiting customer management table 214 is appropriately updated based on information from the person-in-charge terminals 4 or the entrance reception device 5. FIG. 5 is a diagram showing a data configuration of the waiting customer management table 214. The waiting customer management table 214 stores a waiting number, the number of persons, input date and time, and guidance flag in association with one another.

The waiting number is information for identifying the customer waiting for entering the store. The number of persons is information indicating the number of customers in each group. The input date and time is information indicating a date and time when information was input to the entrance reception device 5. The information received from the entrance reception device 5 is registered in the waiting number, the number of persons, and the input date and time. The guidance flag is information indicating whether the customers waiting for entering the store are guided to the table seat. When the customers of the corresponding waiting number are still waiting for entering the store, “0” is registered in the guidance flag. When the customers of the corresponding waiting number are seated at a table by a person in charge, “1” is registered in the guidance flag. The guidance flag is rewritten to “1” based on information from the person-in-charge terminal 4.

The seat management table 215 is a data table for managing the usage states of the table seats of the store. The seat management table 215 is appropriately updated based on the information from the person-in-charge terminals 4. FIG. 6 is a diagram showing a data configuration of the seat management table 215. The seat management table 215 stores a table number, the number of available seats, the usage state, and a seating date and time in association with one another.

The table number is information for identifying a set of table seats. The number of available seats is information indicating the number of persons that can be seated at a set of table seats of the corresponding table number. The table number and the number of available seats are registered in advance by the store. The usage state (situation) is information indicating whether the table seats are in use, cleaned up, or vacant. The usage state may be information indicating only whether or not the table is in a usable situation. The seating date and time is information indicating a date and time when the customer first sits at the table. The usage state and the seating date and time may be appropriately updated based on the information from the person-in-charge terminals 4.

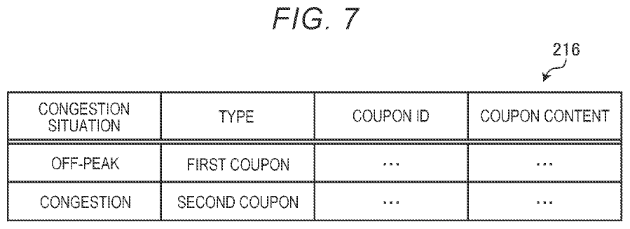

The coupon setting table 216 is a data table for setting a coupon to be transmitted to an order terminal 3, in other words, a coupon to be transmitted to a customer at a particular table. The coupon setting table 216 can be updated by the store as appropriate. FIG. 7 is a diagram showing a data configuration of the coupon setting table 216. The coupon setting table 216 stores a congestion situation (state), an offer type, a coupon ID, and a coupon content in association with one another.

As described above, the congestion situation is the information indicating the congestion state of the store. The offer type is information indicating whether the coupon is a first coupon (first type coupon) to be transmitted in the off-peak state or a second coupon (second type coupon) to be transmitted in the congested state. The coupon ID is information for identifying each coupon. The coupon content is information indicating the content of a privilege or benefit to be obtained by use of the coupon.

The coupon content can be freely set by the store. Examples of the privilege obtained from the first coupon include a discount for an additional ordered commodity and a discount for ordering a specific commodity. Examples of the privilege obtained by the second coupon include a discount for the total amount and a complimentary ticket for a specific commodity that can be used next time (next store visit).

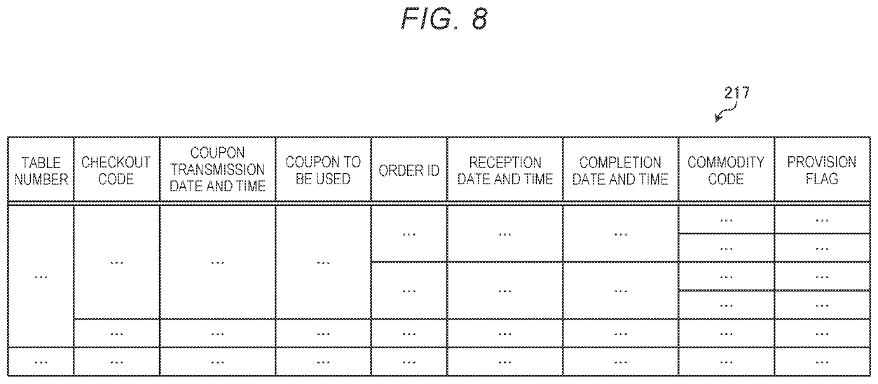

The order information management table 217 is a data table for managing the order information received by the store from the customer. The order information management table 217 is updated based on the information from the order terminals 3 or the person-in-charge terminals 4. FIG. 8 is a diagram showing a data configuration of the order information management table 217. The order information management table 217 stores the table number, the checkout code, a coupon transmission date and time, a coupon to be used, an order ID, a reception date and time, a completion date and time, the commodity code, and a provision flag in association with one another.

As described above, the table number is the information for identifying a table. The checkout code is information for identifying a payment content of a customer of the corresponding table number. When a checkout instruction is received from the order terminal 3, the server device 2 dispenses and registers the checkout code. The server device 2 may dispense the checkout code upon receiving a first order from the order terminal 3. When customers at one table leave the store and next customers use this table, a plurality of checkout codes may be associated with the same table number.

The coupon transmission date and time is information indicating a date and time when the coupon was transmitted to the customer of the corresponding checkout code. When a coupon is not yet transmitted to the customer, the coupon transmission date and time is not registered. The coupon transmission date and time is information for determining whether a use condition is satisfied when a customer uses a coupon.

The coupon to be used is information for identifying a coupon that the customer declares an intention to use, and is, for example, the coupon ID. When the customer inputs a coupon usage request to the order terminal 3, the coupon ID designated by the coupon usage request is registered as the coupon to be used. One coupon to be used is associated with one checkout code in the present embodiment, but a plurality of coupons to be used may be associated with one checkout code. In other words, one group of customers may be allowed to use a plurality of coupons.

The order ID is information for identifying each order. When a plurality of orders are placed from one group of customers, a plurality of order IDs are associated with one checkout code. Upon receiving the order, the server device 2 dispenses the order ID. The reception date and time is information indicating a date and time when the order was received. The completion date and time is information indicating the date and time when all the ordered commodities have been provided to the customers. The reception date and time and the completion date and time are associated with the order ID.

The commodity code is information for identifying the ordered commodity. When a plurality of commodities are ordered in one order, a plurality of commodity codes are associated with an order ID for identifying the order. The provision flag is information indicating whether the commodity of the corresponding commodity code has been provided to the customer. When the commodity of the corresponding commodity code is not yet provided to the customer, “0” is registered in the provision flag. When the commodity of the corresponding commodity code is provided to the customer, “1” is registered in the provision flag. The provision flag is rewritten to “1” based on the information from the person-in-charge terminal 4.

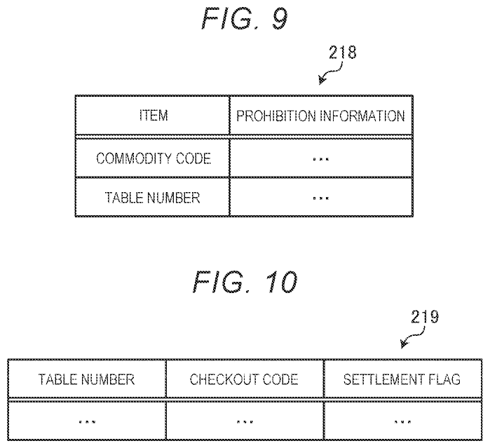

The prohibition information setting table 218 is a data table for setting prohibition information that is used for prohibiting the transmission of the second coupon under certain conditions. The prohibition information setting table 218 can be updated by the store as appropriate. FIG. 9 is a diagram showing a data configuration of the prohibition information setting table 218. The prohibition information setting table 218 stores items and the prohibition information in association with each other.

The item column is for information indicating a type of prohibition information. In the present embodiment, the commodity code and the table number are set as the types. The prohibition information entry is information for more specifically identifying any of the corresponding item types. For example, if the value “A” is registered in the prohibition information corresponding to the commodity code item type, when a commodity with the commodity code “A” is ordered by the customer, the server device 2 will not transmit the second coupon to the customer even in a situation where a transmission condition of the second coupon would otherwise be satisfied. The prohibition information corresponding to commodity codes can be set in advance by the store.

In addition, if the value “1” is registered in the prohibition information corresponding to the table number item type, the server device 2 will not transmit the second coupon to the customers at table No. 1 even in the situation where the transmission condition of the second coupon would otherwise be satisfied. The prohibition information corresponding to the table number item type can be registered according to the input from the person-in-charge terminal 4. In other words, the prohibition information for a table number can be registered according to the judgement of the person in charge. The prohibition information corresponding to the table number can be deleted or reset when the payment by the customers at the registered table number is completed.

Other items such as a number of persons may be set in the prohibition information setting table 218. When the number of persons can be set as an item type when the number of customers of a group is equal to or greater than some set number of persons. Thus, it is possible to prohibit the transmission of a second coupon to a customer in a large group.

The checkout management table 219 is a data table for managing a checkout situation of a customer. The checkout management table 219 is updated based on the information from the order terminals 3 and/or the checkout device 6. FIG. 10 is a diagram showing a data configuration of the checkout management table 219. The checkout management table 219 stores the table number, the checkout code, and a settlement flag in association with one another.

As described above, the table number is the information for identifying a set of table seats (a table), and the checkout code is the information for identifying payment details of a customer. The settlement flag is information indicating whether a payment of the corresponding checkout code has been performed. When the payment is not performed, “0” is registered in the settlement flag, and when the payment is performed, in the settlement flag. The settlement flag is rewritten to “1” based on the information from the checkout device 6.

Referring back to FIG. 2, the hardware of the server device 2 will be described. The display unit 22 is implemented as, for example, a liquid crystal panel, and displays various types of information. For example, the display unit 22 displays an input screen for inputting information into the commodity master 212, the congestion degree determination table 213, the coupon setting table 216, the prohibition information setting table 218, and the like.

The operation unit 23 is used to input information to the control unit 20, and includes a keyboard, a touch panel provided on a surface of the display unit 22, or the like. The operation unit 23 is operated by an employee to input data registered in, for example, the commodity master 212, the congestion degree determination table 213, the coupon setting table 216, and the prohibition information setting table 218 to the control unit 20.

The communication unit 24 is an interface for communicating with external devices such as the order terminals 3, the person-in-charge terminals 4, the entrance reception device 5, and the checkout device 6. The control unit 20 can transmit and receive information (data) to and from the external device by being connected to the external device via the communication unit 24.

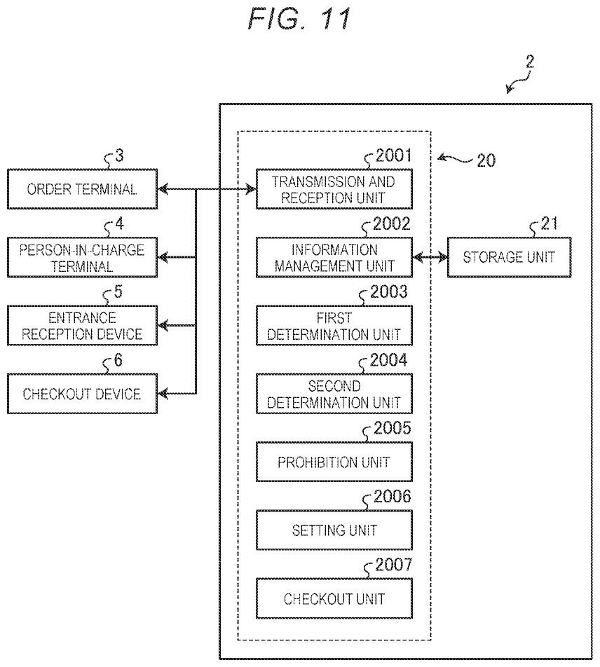

Next, aspects of a functional configuration of the control unit 20 of the server device 2 will be described. FIG. 11 is a block diagram showing functional aspects of the control unit 20. The control unit 20 functions as a transmission and reception unit 2001, an information management unit 2002, a first determination unit 2003, a second determination unit 2004, a prohibition unit 2005, a setting unit 2006, and a checkout unit 2007 when the CPU 201 operates according to a control program stored in the ROM 202 or the storage unit 21. Each function may be implemented by hardware such as a dedicated circuit.

The transmission and reception unit 2001 transmits and receives various types of information to and from the order terminals 3, the person-in-charge terminals 4, the entrance reception device 5, and the checkout device 6. For example, the transmission and reception unit 2001 receives the order information from the order terminal 3. The order information includes the table number and the commodity code of the ordered commodity. The transmission and reception unit 2001 outputs an order completion notification to the order terminal 3. The order completion notification includes the commodity code of the ordered commodity.

The transmission and reception unit 2001 transmits the first coupon to the order terminal 3. The first coupon is transmitted to the order terminal 3 after all the ordered commodities have been provided to the table and the store is presently in the off-peak state. The transmission and reception unit 2001 may also transmit the second coupon to the order terminal 3. The second coupon is transmitted to the order terminal 3 after all the ordered commodities have been provided to the customers at the table and the store is presently in the congested state. That is, the transmission and reception unit 2001 functions as an output unit that outputs a first privilege notification and a second privilege notification.

The transmission and reception unit 2001 receives the coupon usage request from the order terminal 3. The coupon usage request is information declaring that the customer intends to use the coupon and includes the table number to which the coupon was sent and the coupon ID of the coupon to be used.

The transmission and reception unit 2001 receives the order information from the person-in-charge terminal 4. The order information received from the person-in-charge terminal 4 is related to an order orally received from the customer by the person in charge. In addition, the transmission and reception unit 2001 receives the guidance information from the person-in-charge terminal 4. The guidance information is the information indicating that the customers who enter the store have been seated, and includes a table number at which the customers have been seated.

The transmission and reception unit 2001 receives the provision information from the person-in-charge terminal 4. The provision information is information indicating that the ordered commodity has been provided to the corresponding customer and includes the table number of the customer and the commodity code of the provided commodity.

The transmission and reception unit 2001 receives the prohibition information from the person-in-charge terminal 4. The prohibition information is for prohibiting transmission of a coupon to a specific customer and includes a table number of the customer. The order information received by the transmission and reception unit 2001 from the order terminal 3 or the person-in-charge terminal 4 may include a commodity code set in the prohibition information. The transmission and reception unit 2001 functions as an input unit which receives the prohibition information.

The transmission and reception unit 2001 receives the entrance waiting information from the entrance reception device 5. The entrance waiting information includes the number of customers of a group input to the entrance reception device 5 and the entrance waiting number dispensed to the group.

The transmission and reception unit 2001 receives a payment information request from the checkout device 6, and transmits the payment information to the checkout device 6 in response to the request. The payment information includes information for the checkout device 6 to print a receipt, specifically, the commodity information of the payment target commodity and an amount of payment. The transmission and reception unit 2001 receives a payment completion notification from the checkout device 6. The payment completion notification is information indicating that the payment identified by the checkout code is completed and includes the checkout code.

The information management unit 2002 manages various types of information stored in the storage unit 21. Here, the information management means writing or reading various types of information (data) to or from the storage unit 21.

For example, the information management unit 2002 updates the waiting customer management table 214 based on the entrance waiting information and the guidance information received by the transmission and reception unit 2001. Specifically, the information management unit 2002 registers the waiting number, the number of persons, and the input date and time included in the entrance waiting information in the waiting customer management table 214. At this time, the information management unit 2002 registers “0” in the guidance flag. When the transmission and reception unit 2001 receives the above guidance information, the information management unit 2002 rewrites the guidance flag to “1”.

The information management unit 2002 updates the seat management table 215 based on the guidance information received by the transmission and reception unit 2001. Specifically, when the transmission and reception unit 2001 receives the guidance information, the information management unit 2002 rewrites the usage situation in the seat management table 215 corresponding to the table number included in the guidance information to “in use” and registers the seating date and time.

The information management unit 2002 updates the order information management table 217 based on the order information, the coupon usage request, and the provision information received by the transmission and reception unit 2001. Specifically, when the transmission and reception unit 2001 receives the order information, the information management unit 2002 dispenses the order ID and registers the order ID in association with the table number included in the order information. Then, the information management unit 2002 registers the commodity code included in the order information in association with the dispensed order ID, and registers the reception date and time. At this time, the information management unit 2002 registers “0” in the provision flag.

The information management unit 2002 registers a date and time when the transmission and reception unit 2001 transmits a first coupon or a second coupon. When the transmission and reception unit 2001 receives the coupon usage request, the information management unit 2002 registers the coupon ID included in the coupon usage request as a coupon to be used associated with the table number included in the coupon usage request. When the transmission and reception unit 2001 receives the provision information, the information management unit 2002 rewrites the provision flag in the provision information to “1”. The information management unit 2002 registers the date and time when all the provision flags corresponding to the order IDs have been set to “1” as the completion date and time.

The information management unit 2002 updates the checkout management table 219 based on the payment completion notification received by the transmission and reception unit 2001. Specifically, when the transmission and reception unit 2001 receives the payment completion notification, the information management unit 2002 rewrites the settlement flag corresponding to the checkout code to “1”.

The information management unit 2002 reads the congestion information necessary for calculating the congestion degree from the waiting customer management table 214 and the seat management table 215 periodically (for example, at intervals of 1 minute to 5 minutes) at a predetermined set timing. Specifically, the information management unit 2002 reads the number of customers or the number of persons waiting for entering the store from the table waiting customer management 214. In addition, the information management unit 2002 reads the number of table seats in a vacant state from the seat management table 215. The information management unit 2002 functions as a congestion information acquisition unit that acquires the congestion information indicating the congestion situation in the store.

The information management unit 2002 reads the commodity code corresponding to the table number in which the checkout code is not registered and having the provision flag of “1” from the order information management table 217 at the set timing. The information management unit 2002 functions as a provision information acquisition unit that acquires the provision information indicating that an ordered commodity has been provided to the corresponding customer.

The provision information acquisition unit may acquire an image of a table for the provision information from a camera that monitors the store. In this case, the control unit 20 determines whether the ordered commodities of the customers at a table have been completely provided from the camera image (s).

The first determination unit 2003 calculates the congestion degree based on the congestion information read by the information management unit 2002, and determines the congestion situation of the store based on the congestion degree. The first determination unit 2003 calculates the congestion degree by the above-described calculation method. Then, the first determination unit 2003 refers to the congestion degree determination table 213, and determines that the congestion situation is the off-peak state when the calculated congestion degree is equal to or less than 0.3.

The first determination unit 2003 similarly determines that the congestion situation is the congested state when the calculated congestion degree is equal to or greater than 0.8. When the calculated congestion degree is greater than 0.3 but less than 0.8, the first determination unit 2003 determines that the congestion situation is the normal state.

The second determination unit 2004 determines, based on the provision information acquired by information management unit 2002, that the customers are in a provision completion state in which all the ordered commodities of one group of customers are provided. Specifically, the second determination unit 2004 determines whether there is provision completion order information in which the checkout code is not registered and all the provision flags are rewritten to “1” in the order information management table 217. When there is the provision completion order information, the second determination unit 2004 determines that the customers of the table number corresponding to the provision completion order information are in the provision completion state.

When prohibition information has been sent to the transmission and reception unit 2001, the prohibition unit 2005 prohibits the transmission and reception unit 2001 from outputting the second privilege notification. Specifically, the prohibition unit 2005 prohibits the transmission of the second coupon to the customer who orders a commodity of the commodity code registered in the prohibition information setting table 218. In addition, the prohibition unit 2005 prohibits the transmission of the second coupon to the customer of a table number registered in the prohibition information setting table 218.

The setting unit 2006 sets the prohibition information. Specifically, the setting unit 2006 sets the prohibition information in the prohibition information setting table 218 based on, for example, information input by the operation unit 23.

The checkout unit 2007 performs a checkout process for allowing the customer to perform a payment by the checkout device 6. For example, when the transmission and reception unit 2001 receives the checkout instruction from the order terminal 3, the checkout unit 2007 reads unsettled order information corresponding to the table number included in the checkout instruction from the order information management table 217. Then, the checkout unit 2007 calculates an amount of payment due based on the read order information. The checkout unit 2007 dispenses a checkout code and registers the table number included in the checkout instruction and the checkout code in the checkout management table 219 in association with each other.

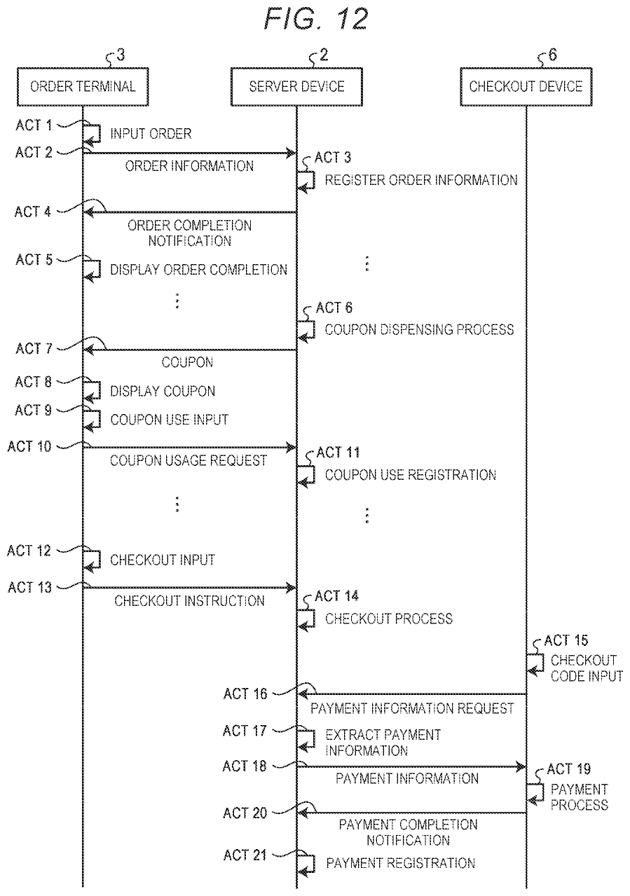

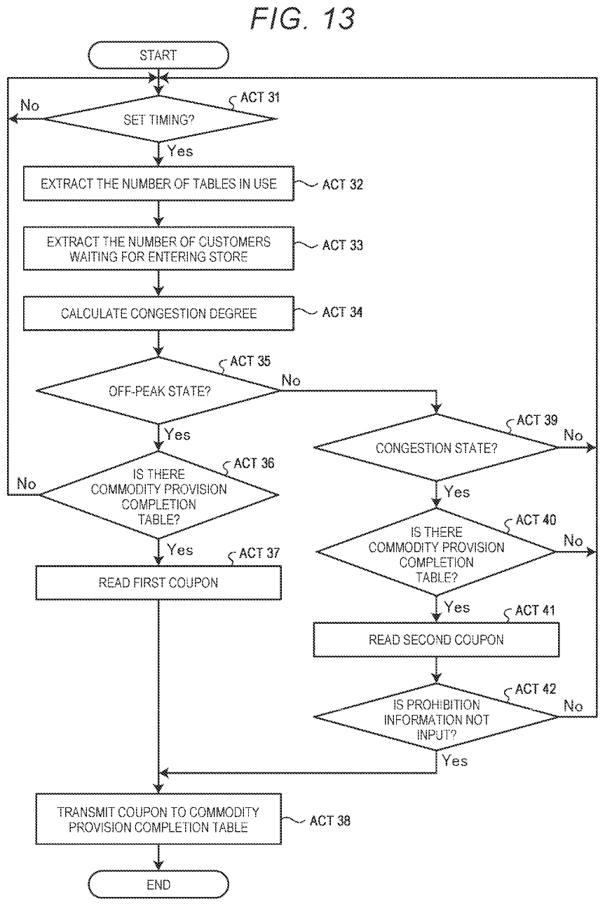

Next, operations of the store system 1 will be schematically described. FIG. 12 is a sequence chart showing a flow of operations of the server device 2, the order terminal 3, and the checkout device 6. The sequence chart shows operations after the customer is guided to the table seat, and shows operations when a coupon is dispensed during drinking and eating of the customer and the coupon is used.

First, when a customer selects a commodity to order, the customer operates the order terminal 3 to input an order (ACT 1). The order terminal 3 transmits the input order information to the server device 2 (ACT 2).

The server device 2 registers the received order information in the order information management table 217 (ACT 3). The server device 2 transmits the order completion notification to the order terminal 3 (ACT 4). The order terminal 3 displays the information included in the order completion notification (ACT 5).

Thereafter, the customer inputs an additional order to the order terminal 3 whenever necessary. Every time an order is input to the order terminal 3, the processes of ACT 1 to ACT 5 are repeated. The server device 2 executes a regular coupon dispensing process (ACT 6). When a coupon transmission condition is satisfied, a coupon is dispensed by the coupon dispensing process. The server device 2 transmits the dispensed coupon to the order terminal 3 (ACT 7). At this time, the server device 2 registers a coupon transmission date and time in the order information management table 217.

The order terminal 3 displays the received coupon on the monitor (ACT 8). When the customer checks the coupon displayed on the monitor of the order terminal 3 and wishes to use the coupon, a coupon use input is performed on the order terminal 3 (ACT 9). The order terminal 3 transmits the coupon usage request to the server device 2 (ACT 10).

The server device 2 performs coupon use registration in response to the coupon usage request (ACT 11). Specifically, the server device 2 registers the coupon ID corresponding to the table number included in the coupon usage request as the coupon to be used in the order information management table 217. Thereafter, every time an order is input to the order terminal 3, the processes of ACT 1 to ACT 5 are repeated.

When the customer leaves the store, a checkout input is performed on the order terminal 3 (ACT 12). The order terminal 3 transmits the checkout instruction to the server device 2 (ACT 13). Upon receiving the checkout instruction, the server device 2 executes the checkout process (ACT 14). The server device 2 dispenses the checkout code through the checkout process.

In the present embodiment, the server device 2 transmits the checkout code to a printer to print a checkout slip. For example, a code symbol indicating the checkout code is printed on the checkout slip. The person in charge hands over the printed checkout slip to the customer. In some examples, a printer may be provided for each table, and in this case, the customer can obtain the checkout slip without intervention of a person in charge. In other examples, the server device 2 may transmit the dispensed checkout code to a smartphone of the customer. In this case, the checkout slip is not printed.

The customer who obtains the checkout slip causes the scanner of the checkout device 6 to read the code symbol printed on the checkout slip. As a result, the checkout code is input to the checkout device 6 (ACT 15). The checkout device 6 transmits the payment information request to the server device 2 (ACT 16).

The server device 2 extracts the payment information corresponding information request (ACT 17). Specifically, the server device 2 reads the order information corresponding to the checkout code included in the payment information request from the order information management table, and calculates the amount of payment due for the corresponding order information. The server device 2 transmits the payment information including the calculated amount for payment and the like to the checkout device 6 (ACT 18).

The checkout device 6 executes a payment process (ACT 19). For example, the checkout device 6 receives cash inserted by a customer and discharges change as necessary. Accordingly, the checkout device 6 completes the payment by cash settlement of the customer. Alternatively, the checkout device 6 communicates with a settlement server of a settlement operator to complete the payment by cashless settlement of the customer. The checkout device 6 transmits the payment completion notification to the server device 2 (ACT 20).

The server device 2 performs payment registration in response to the payment completion notification (ACT 21). Specifically, the server device 2 updates the checkout management table 219 by rewriting the settlement flag corresponding to the checkout code included in the payment completion notification to “1”.

By performing the above operation, the store system 1 can perform a process of receiving the order information from the customer, transmitting the coupon to the customer, and completing the payment by the customer.

Next, the coupon dispensing process executed by the control unit 20 of the server device 2 will be described. The coupon dispensing process is a process for transmitting a first coupon or a second coupon to the customer when a coupon transmission condition is satisfied. FIG. 13 is a flowchart of the coupon dispensing process performed by the control unit 20 of the server device 2.

The control unit 20 determines whether a predetermined set timing comes (ACT 31), and if not (N in ACT 31), the control unit 20 returns to the process of ACT 31 and stands by. When the set timing arrives (Y in ACT 31), the information management unit 2002 refers to the seat management table 215 and extracts the number of table seats in use (ACT 32). Subsequently, the information management unit 2002 refers to the waiting customer management table 214 and extracts the number of customers waiting for entering the store (ACT 33).

The first determination unit 2003 calculates the congestion degree based on the number of table seats provided in the store, the number of table seats in use, and the number of customers waiting for entering the store (ACT 34). The first determination unit 2003 identifies whether the congestion situation is the off-peak state by reference to the congestion degree determination table 213 (ACT 35). Specifically, the first determination unit 2003 determines whether the calculated congestion degree is 0.3 or less.

When the congestion situation is the off-peak state (Y in ACT 35), the second determination unit 2004 refers to the order information management table 217 and determines whether there is a table (a “completed table”) for which all the ordered commodities have been completely provided (ACT 36). Specifically, the second determination unit 2004 determines whether there is a table number for which “1” is registered in all the corresponding provision flags in the order information management table 217.

When there is no completed table (N in ACT 36), the control unit 20 determines that there is no customer to which the coupon is to be transmitted, and returns to the process of ACT 31. When there is the completed table (Y in ACT 36), the information management unit 2002 reads the first coupon from the coupon setting table 216 (ACT 37).

Subsequently, the transmission and reception unit 2001 transmits the read coupon (first coupon) to the order terminal 3 on the completed table (ACT 38). When there are a plurality of completed tables, the transmission and reception unit 2001 transmits the coupons to the order terminals 3 on all the completed tables. Then, the control unit 20 ends the coupon dispensing process.

In the process of ACT 35, when the congestion situation is not the off-peak state (N in ACT 35), the first determination unit 2003 determines whether the congestion situation is the congested state with reference to the congestion degree determination table 213 (ACT 39). Specifically, the first determination unit 2003 whether determines the calculated congestion degree is 0.8 or greater.

When the congestion situation is not the congested state but the normal state (N in ACT 39), the control unit 20 determines that there is no customer to which the coupon is to be transmitted, and returns to the process of ACT 31. When the congestion situation is the congested state (Y in ACT 39), the second determination unit 2004 determines whether there is completed table (ACT 40).

When there is no completed table (N in ACT 40), the control unit 20 determines that there is no customer to which the coupon is to be transmitted, and returns to the process of ACT 31. When there is a completed table (Y in ACT 40), the information management unit 2002 reads a second coupon from the coupon setting table 216 (ACT 41).

Next, the control unit 20 determines whether the prohibition information is not input (ACT 42). Specifically, the control unit 20 determines whether the table number of the completed table is registered in the prohibition information setting table 218. In addition, the control unit 20 determines whether the commodity code registered in the order information management table 217 that corresponds to the table number of the completed table is registered in the prohibition information setting table 218.

When the table number and the commodity code described above are not registered in the prohibition information setting table 218, the control unit 20 determines that the prohibition information is not input. The determination as to whether the prohibition information is not input is performed on all the completed tables.

When the prohibition information is input (N in ACT 42), the control unit 20 returns to the process of ACT 31. When the prohibition information is not input (Y in ACT 42), the control unit 20 proceeds to the process of ACT 38. In this case, the coupon transmitted in ACT 38 is the second coupon.

By performing the coupon dispensing process described above, the server device 2 can transmit the first coupon or the second coupon to the customer according to the congestion situation in the store and an eating and drinking state of the customer. Accordingly, the store can expect an additional order of the customer in the store when the store is in the off-peak state, and can be expected to increase the customer turnover rate when the store is in the congested state. Accordingly, the server device 2 can contribute to increases in sales of the store.

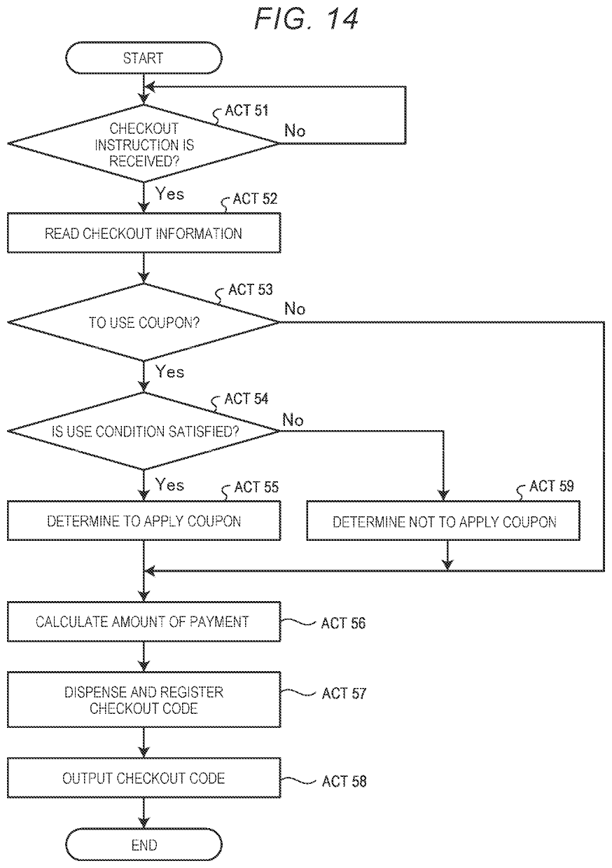

Next, the checkout process executed by the control unit 20 of the server device 2 will be described. The checkout process is a process of the customer performing a payment at the checkout device 6. FIG. 14 is a flowchart of the checkout process performed by the control unit 20 of the server device 2.

The control unit 20 determines whether the transmission and reception unit 2001 receives the checkout instruction from the order terminal 3 (ACT 51), if the checkout instruction is not received (N in ACT 51), the control unit 20 returns to the process of ACT 51 and stands by. When the transmission and reception unit 2001 receives the checkout instruction (Y in ACT 51), the information management unit 2002 reads the checkout information of the table number included in the checkout instruction from the order information management table 217 (ACT 52).

The checkout unit 2007 determines whether the coupon to be used is registered in the read order information (ACT 53). In other words, the checkout unit 2007 determines whether the customer who performs the payment intends to use a coupon.

When a coupon to be used is registered (Y in ACT 53), the checkout unit 2007 determines whether the customer satisfies a coupon use condition (ACT 54). When the coupon to be used by the customer is a first coupon, the checkout unit 2007 determines that the coupon use condition is satisfied if the customer placed an additional order after the coupon transmission. Whether there is an additional order can be determined by comparing the coupon transmission date and time in the order information management table 217 with the reception date and time corresponding to the order ID.

When the coupon to be used by the customer is a second coupon, the checkout unit 2007 determines that the coupon use condition is satisfied if a checkout instruction was input to the order terminal 3 within a predetermined period of time (for example, within 15 minutes) after the coupon transmission. Whether the checkout instruction has been input within the predetermined period of time can be determined based on a date and time when the server device 2 receives the checkout instruction and the coupon transmission date and time in the order information management table 217.

When the use condition is satisfied (Y in ACT 54), the checkout unit 2007 determines to apply the coupon (ACT 55). Subsequently, the checkout unit 2007 calculates an amount of payment (ACT 56). In this case, the checkout unit 2007 calculates the amount of payment with the coupon applied. The checkout unit 2007 dispenses and registers the checkout code in the order information management table 217 and the checkout management table 219 (ACT 57).

Next, the transmission and reception unit 2001 outputs the checkout code (ACT 58). The transmission and reception unit 2001 transmits a checkout slip dispensing instruction including the checkout code to, for example, the printer. Then, the control unit 20 ends the checkout process.

When a coupon is not to be used in the process of ACT 53 (N in ACT 53), the control unit 20 skips the processes of ACT 54 and ACT 55 and proceeds to the process of ACT 56. In this case, the checkout unit 2007 calculates the amount of payment with no coupon applied.

When the use condition is not satisfied in the process of ACT 54 (N in ACT 54), the checkout unit 2004 determines not to apply a coupon (ACT 59). Then, the control unit 20 proceeds to the process of ACT 56. In this case, the checkout unit 2007 calculates the amount of payment with no coupon applied.

By performing the above checkout process, the server device 2 can allow the customer to perform a payment on the checkout device 6. The server device 2 can calculate the amount of payment after determining whether the coupon can be applied or not.

As described above, the server device 2 according to the embodiment includes: the congestion information acquisition unit (information management unit 2002) that acquires the congestion information; the first determination unit 2003 that determines, based on the congestion information acquired by the congestion information acquisition unit, that the store is in the off-peak state when the congestion degree in the store is equal to or less than a first set value; the provision information acquisition unit (information management unit 2002) that acquires the provision information indicating that an ordered commodity ordered by a customer in the store is provided to the customer; the second determination unit 2004 that determines, based on the provision information acquired by the provision information acquisition unit, the provision completion state in which all the ordered commodities of one group of customers are provided; an output unit (transmission and reception unit 2001) that outputs, to a customer in the provision completion state, a first privilege notification indicating that a privilege is granted under a condition that an additional order is placed, in a state in which the first determination unit 2003 determines that the store is in the off-peak state and the second determination unit 2004 determines that the customer is in the provision completion state.

Accordingly, the server device 2 can promote an additional order of the customer in the store when the store is in the off-peak state. Accordingly, the server device 2 can contribute to increases in sales of the store.

In addition, in the server device 2 according to the embodiment, the first determination unit 2003 determines, based on the congestion information, that the store is in the congested state when the congestion degree in the store is equal to or greater than a second set value that is higher than the first set value, and the output unit (transmission and reception unit 2001) outputs, to a customer in the provision completion state, a second privilege notification indicating that a privilege is granted under a condition that the customer leaves the store within a set time, in a state in which the first determination unit 2003 determines that the store is in the congested state and the second determination unit 2004 determines that the customer is in the provision completion state.

Accordingly, the server device 2 can increase the customer turnover rate due to customers leaving the store earlier when the store is in the congested state. Accordingly, the server device 2 can contribute to the increase in sales of the store.

In addition, the server device 2 according to the embodiment further includes: an input unit (transmission and reception unit 2001) which receives prohibition information; and a prohibition unit 2005 that prohibits the output unit (transmission and reception unit 2001) from outputting the second privilege notification when the prohibition information is input to the input unit.

Accordingly, the server device 2 can prevent the second privilege notification from being output to a customer who may feel uncomfortable with the second privilege notification for prompting early leaving. Therefore, the store can prevent the customer from feeling uncomfortable.

In addition, the server device 2 according to the embodiment further includes: a setting unit 2006 capable of setting the prohibition information.

Accordingly, the server device 2 can freely set a condition of the prohibition of the output of the second privilege notification for prompting early leaving. Therefore, the store can run according to the situation of the store itself.

The server device 2 according to the embodiment sets the prohibition information commodity identification as information for identifying a commodity set in advance or customer identification information for identifying a customer.

Accordingly, the server device 2 can prohibit the output of the second privilege notification to a customer who orders a commodity set in advance or a customer identified by an employee. Therefore, the store can further be run according to the current situation of the store.

In the above embodiment, the control program executed by the server device 2 may be provided by being recorded on a non-transitory, computer-readable recording medium such as a CD-ROM. The control program executed by server device 2 may be stored in a computer connected to a network such as the Internet and provided by being downloaded via the network, or may be accessed via the network such as the Internet.

While the embodiment is described above, the embodiment is presented as an example only, and is not intended to limit the scope of the embodiment. The above-described embodiment can be implemented in various other forms, and various omissions, substitutions, and changes can be made without departing from the spirit of the embodiment. The accompanying claims and their equivalents are intended to cover such forms or modifications as would fall within the scope and spirit of the disclosure.

What is claimed is:

1. An information processing device for store management, comprising:
a storage unit; and
a control unit configured to:
calculate a congestion value for a store based on a number of presently occupied seats and a total number of seats in the store;
identify whether the store is in an off-peak state when a congestion value is equal to or less than a first set value;
acquire item provision information indicating whether an item ordered by a customer in the store has been provided to the customer;
determine based on the acquired provision information whether all ordered items of customers at a table have been provided to the customers; and
when the store is in the off-peak state, transmit a first coupon to the table for which all ordered items for the customers at the table have been provided to the customers, the first coupon granting a privilege associated with a placing of an additional order for an item.

2. The information processing device according to claim 1, wherein the control unit is further configured to:
identify whether the store is in a congested state when the congestion value is equal to or greater than a second set value that is higher than the first set value.

3. The information processing device according to claim 2, wherein the control unit is further configured to:
when the store is in the congested state, transmit a second coupon to the table for which all ordered items at the table have been provided to the customer, the second coupon granting a privilege conditioned on the customers leaving the store within a set time.

4. The information processing device according to claim 2, further comprising:
a network interface configured to connect to a plurality of table order terminals, a plurality of wait staff terminals, a payment terminal, and an entrance terminal, wherein
the control unit is further configured to receive information regarding occupied tables from the plurality of wait staff terminals and information indicating a number of customers waiting for tables from the entrance terminal and calculate the congestion value accordingly.

5. The information processing device according to claim 4, wherein the control unit is further configured to receive information regarding ordered items and item provision information via the network interface.

6. The information processing device according to claim 4, wherein the control unit is further configured to transmit the first coupon to a table order terminal among the plurality of table order terminals.

7. The information processing device according to claim 4, wherein the control unit is further configured to:
when the store is in the congested state, transmit a second coupon to the table for which all ordered items at the table have been provided to the customer, the second coupon granting a privilege conditioned on the customers, and
receive prohibition information from the plurality of wait staff terminals indicating a table to which the second coupon is not to be sent.

8. The information processing device according to claim 7, wherein the storage unit stores the prohibition information.

9. The information processing device according to claim 8, wherein the stored prohibition information includes commodity identification information for identifying a commodity the ordering of which by a customer at a table precludes the sending of the second coupon.

10. A store order handling system, comprising:
an entrance terminal configured to receive a request for a table at a store;
a plurality of order terminals, each located at one of a plurality of tables at the store and configured to receive customer orders from customers for items;
a plurality of wait staff terminals configured to receive customer orders from customers for items and table status updates; and
a store server connected to the entrance terminal, the plurality of order terminals, and the plurality of wait staff terminals via a network, the store server including:
a storage unit; and
a control unit configured to:
calculate a congestion value for the store based on a number of presently occupied seats and a total number of seats in the store;
identify whether the store is in an off-peak state when a congestion value is equal to or less than a first set value;
acquire item provision information indicating whether an item ordered by a customer in the store has been provided to the customer;
determine based on the acquired provision information whether all ordered items of customers at a table have been provided to the customers; and
when the store is in the off-peak state, transmit a first coupon to the table for which all ordered items for the customers at the table have been provided to the customers, the first coupon granting a privilege associated with a placing of an additional order for an item.

11. The store order handling system according to claim 10, wherein the control unit is further configured to:
identify whether the store is in a congested state when the congestion value is equal to or greater than a second set value that is higher than the first set value.

12. The store order handling system according to claim 11, wherein the control unit is further configured to:
when the store is in the congested state, transmit a second coupon to the table for which all ordered items at the table have been provided to the customer, the second coupon granting a privilege conditioned on the customers leaving the store within a set time.

13. A method for a store server device, the method comprising:
calculating a congestion value for a store based on a number of presently occupied seats and a total number of seats in the store;
identifying whether the store is in an off-peak state when a congestion value is equal to or less than a first set value;
acquiring item provision information indicating whether an item ordered by a customer in the store has been provided to the customer;
determining based on the acquired provision information whether all ordered items of customers at a table have been provided to the customers; and
when the store is in the off-peak state, transmitting a first coupon to the table for which all ordered items for the customers at the table have been provided to the customers, the first coupon granting a privilege associated with a placing of an additional order of an item.

14. The method according to claim 13, further comprising:
identifying whether the store is in a congested state when the congestion value is equal to or greater than a second set value that is higher than the first set value; and
when the store is in the congested state, transmitting a second coupon to the table for which all ordered items at the table have been provided to the customer, the second coupon granting a privilege conditioned on the customers leaving the store within a set time.

15. The method according to claim 14, further comprising:
receiving information regarding occupied tables from a plurality of wait staff terminals and information indicating a number of customers waiting for tables from an entrance terminal and calculate the congestion value accordingly.

16. The method according to claim 14, further comprising:
receiving information regarding occupied tables from a plurality of wait staff terminals and information indicating a number of customers waiting for tables from an entrance terminal and calculate the congestion value accordingly, wherein
when the calculated value the store is in the congested state, transmit a second coupon to the table for which all ordered items at the table have been provided to the customer, the second coupon granting a privilege conditioned on the customers, and
receive prohibition information from the plurality of wait staff terminals indicating a table to which the second coupon is not to be sent.

17. The method according to claim 16, further comprising:
storing prohibition information in a storage unit.

18. The method according to claim 17, wherein the stored prohibition information includes commodity identification information for identifying a commodity the ordering of which by a customer at a table precludes the sending of the second coupon.

19. The method according to claim 13, further comprising:
receiving information regarding ordered items from a plurality of order terminals, each order terminal being located at a table of the store.

20. The method according to claim 19, wherein the first coupon is transmitted to a table order terminal among the plurality of table order terminals.
